(19) United States
(12) Patent Application Publication
(10) Pub. No.: US 2026/0167463 A1
(43) Pub. Date: Jun. 18, 2026

(54) CRANE AND MOUNTING ASSEMBLY STRUCTURE

(71) Applicant: XUZHOU HEAVY MACHINERY CO., LTD., Jiangsu (CN)

(72) Inventors: Xiangdong CHEN, Jiangsu (CN); Yuqin FU, Jiangsu (CN); Bo LI, Jiangsu (CN); Yubin DING, Jiangsu (CN); Zhenkun LI, Jiangsu (CN); Yan SHAO, Jiangsu (CN)

(73) Assignee: XUZHOU HEAVY MACHINERY CO., LTD., Jiangsu (CN)

(21) Appl. No.: 19/533,260

(22) Filed: Feb. 8, 2026

Related U.S. Application Data
(63) Continuation of application No. PCT/CN2024/125747, filed on Oct. 18, 2024.

(30) Foreign Application Priority Data
Jan. 5, 2024 (CN) 202410017891.5

(51) Int. Cl. B66C 23/70; B66C 23/82; B66C 23/88

(52) U.S. Cl. CPC B66C 23/70; B66C 23/82; B66C 23/88

(57) ABSTRACT

A crane and a mounting assembly structure are provided. The crane includes a boom, a luffing cylinder and a tower jib structure for function switching, wherein the tower jib structure includes a jib frame, a tower jib connecting frame connected to the boom, and a mounting assembly structure, and the tower jib connecting frame and the jib frame are connected to each other by means of the mounting assembly structure. The disclosure has the characteristics of simple operation, flexible use and safe operation since different mounting assembly structures are assembled by different elements.

### CROSS-REFERENCE TO RELATED APPLICATION

This application is a continuation of international application of PCT application serial no. PCT/CN2024/125747, filed on Oct. 18, 2024, which claims the priority benefit of China application no. 202410017891.5 filed on Jan. 5, 2024. The entirety of each of the above mentioned patent applications is hereby incorporated by reference herein and made a part of this specification.

### TECHNICAL FIELD

The disclosure relates to the field of construction machinery, and more particularly to a crane and a mounting assembly structure.

### BACKGROUND

Crane tower jib structures have advantages of high structural performance and good safety, and are therefore widely used in the engineering and mechanical fields. Existing tower jibs are closed structures composed of a jib frame, support frames, and connecting tie plates, where the support frames and the connecting tie plates cooperate to significantly improve the lifting capacity of the jib frame. When performing luffing operations on the aforesaid tower jibs, the operation can only be realized through a luffing winch. However, the operation is complex due to a high reeving ratio of a wire rope extending from the luffing winch. In addition, existing tower jibs are further provided with a mechanical anti-back-tipping structure. The mechanical anti-back-tipping structure is composed of an anti-back-tipping hinge point on a jib connecting frame, a mechanical anti-back-tipping strut, a counterweight, and an anti-back-tipping slideway provided on a bottom jib section. When the bottom jib section tilts backward to a certain angle, the anti-back-tipping strut engages with a counterweight slot to provide an anti-back-tipping function. However, the introduction of this structure makes the entire tower jib structure relatively complex, and since the anti-back-tipping strut cooperates with the counterweight slot in a movable manner, there is a risk of disengagement, resulting in unsafe operation. In addition, in actual use, some operating conditions with low lifting capacity requirements desire to operate only the jib frame without using the luffing winch, so as to simplify operation, increase operating speed, and shorten operation time. However, the existing tower jib structures are closed, which is not conducive to flexible use.

### SUMMARY

The disclosure aims to provide a crane and a mounting assembly structure that are easy to operate, flexible in use, and safe to operate.

The crane provided by the disclosure includes a boom and a luffing cylinder, and further includes a tower jib structure for function switching, where the tower jib structure includes a jib frame, a tower jib connecting frame connected to the boom, and a mounting assembly structure, the tower jib connecting frame and the jib frame are movably connected or fixedly connected to each other by means of the mounting assembly structure, and the luffing cylinder controls the boom to drive the tower jib connecting frame to raise and lower.

The mounting assembly structure provided by the disclosure includes a transition joint and a connecting switch, where the transition joint includes a first transition joint and a second transition joint.

The first transition joint is arranged at a front end of the tower jib connecting frame, the second transition joint is arranged at a rear end of the jib frame, and the first transition joint is connected to or disconnected from the second transition joint by means of the connecting switch.

The mounting assembly structure provided by the disclosure includes a transition joint, a connecting switch, a tower cap connected to the tower jib connecting frame, and a bottom jib section connected to the jib frame; and the transition joint includes a first transition joint and a second transition joint; and the first transition joint is arranged at a front end of the tower cap, the second transition joint is arranged at a rear end of the bottom jib section, and the first transition joint is connected to or disconnected from the second transition joint by means of the connecting switch.

Further, when the connecting switch is engaged, the tower jib connecting frame is connected to the jib frame, and the luffing cylinder controls the tower jib connecting frame to cause the jib frame to raise and lower; and when the connecting switch is disengaged, the tower jib connecting frame is disconnected from the jib frame.

Further, the tower jib structure includes a luffing winch, a luffing rope, and a connecting tie plate, and an end of the luffing rope extends from the luffing winch; the mounting assembly structure further includes a support frame, both the support frame and the connecting tie plate extend from an end of the luffing rope away from the luffing winch, the other end of the support frame is connected to an end of the first transition joint, and the other end of the connecting tie plate is connected to an end of the jib frame away from the transition joint; and when the connecting switch is disengaged, operation of the luffing winch controls the luffing rope to cause the support frame to rotate, thereby driving the jib frame to raise or lower.

Further, at least one support frame is provided.

Further, the connecting switch is a pin, holes are formed in the first transition joint and the second transition joint, and the pin cooperates with the holes to achieve engagement and disengagement.

Further, the tower jib structure also includes a conversion tie plate, and the first transition joint and the second transition joint are disconnected and connected through cooperation between the conversion tie plate and the pin.

Further, a plurality of transition joints and connecting switches cooperating with the transition joints are provided.

Further, at least two transition joints are symmetrically arranged from top to bottom in a lifting direction of the jib frame.

The disclosure has the following significant advantages: (1) The disclosure is easy to operate. The tower jib connecting frame and the jib frame are movably or fixedly connected to each other, and when the tower jib connecting frame and the jib frame are movably connected, raising and lowering of the jib frame can be realized when the tower jib connecting frame performs luffing operation or does not perform luffing operation, thereby making the operation simple, enabling function switching and improving utilization efficiency of the jib frame; (2) the disclosure is flexible in use. Transition joints are arranged on the tower jib connecting frame and the jib frame, and connecting switches are provided to connect the transition joints. The connecting switches have open and closed states, facilitating disconnection and connection between the tower jib connecting frame and the jib frame, and meeting requirements of various different operating conditions; and (3) the disclosure is safe in operation. At least two transition joints and connecting switches cooperating with the transition joints are symmetrically arranged from top to bottom in a lifting direction of the jib frame, such that the tower jib connecting frame and the jib frame are maintained in the same straight line, preventing an end of the jib frame away from the crane from bending toward the crane, simplifying the structure while offering strong stability and high safety during operation.

### BRIEF DESCRIPTION OF THE DRAWINGS

FIG. 1 is an overall schematic diagram of a crane according to the disclosure.

FIG. 2 is a schematic diagram illustrating a connecting switch in an open state according to the disclosure.

FIG. 3 is a schematic diagram illustrating a connecting switch in a closed state according to the disclosure.

FIG. 4 is a schematic diagram illustrating cooperation between a connecting switch and a conversion tie plate according to the disclosure.

FIG. 5 is a schematic diagram of installation when a crane is provided with two support frames.

### DETAILED DESCRIPTIONS OF THE EMBODIMENTS

The disclosure will be further described in detail below in conjunction with the accompanying drawings and specific embodiments.

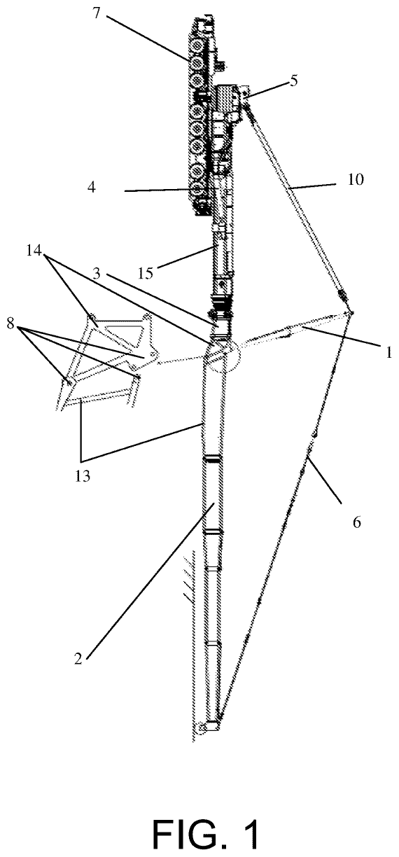

With reference to FIG. 1, the disclosure provides a crane and a mounting assembly structure.

Specifically, a crane 7 includes a boom 15 and a luffing cylinder 4, and further includes a tower jib structure for function switching. The tower jib structure includes a jib frame 2, a tower jib connecting frame 3 connected to the boom 15, and a mounting assembly structure. The tower jib connecting frame 3 and the jib frame 2 are movably connected or fixedly connected to each other by means of the mounting assembly structure, and the luffing cylinder 4 controls the boom 15 to drive the tower jib connecting frame 3 to raise and lower.

The disclosure provides two embodiments of the mounting assembly structure. Embodiment 1: A mounting assembly structure includes a transition joint 8 and a connecting switch 9, and the transition joint 8 includes a first transition joint 81 and a second transition joint 82.

The first transition joint 81 is arranged at a front end of the tower jib connecting frame 3, the second transition joint 82 is arranged at a rear end of the jib frame 2, and the first transition joint 81 is connected to or disconnected from the second transition joint 82 by means of the connecting switch 9.

Embodiment 2: A mounting assembly structure includes a transition joint 8, a connecting switch 9, a tower cap 14 connected to the tower jib connecting frame 3, and a bottom jib section 13 connected to the jib frame 2; and the transition joint 8 includes a first transition joint 81 and a second transition joint 82; and

the first transition joint 81 is arranged at a front end of the tower cap 14, the second transition joint 82 is arranged at a rear end of the bottom jib section 13, and the first transition joint 81 is connected to or disconnected from the second transition joint 82 by means of the connecting switch 9.

The disclosure is further described below.

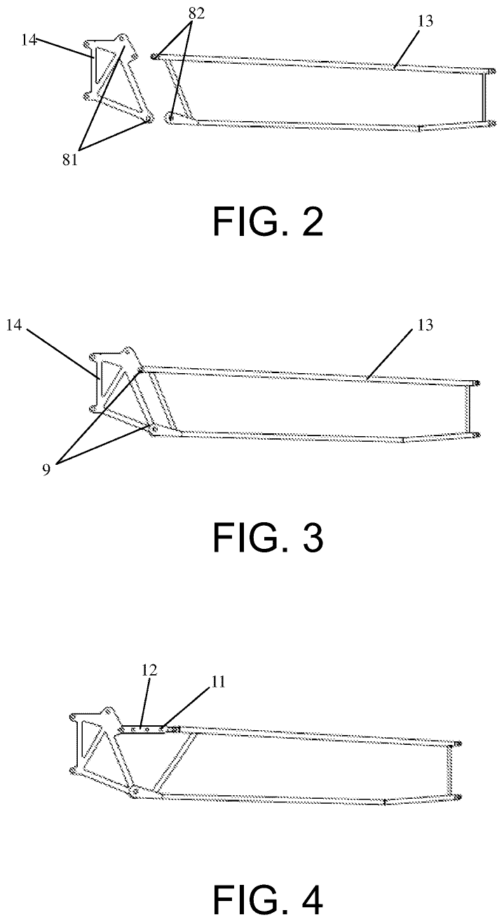

With reference to FIGS. 2 and 3, the connecting switch 9 includes a closed state and an open state. When the connecting switch 9 is engaged, the tower jib connecting frame 3 is connected to the jib frame 2; and when the connecting switch 9 is disengaged, the tower jib connecting frame 3 is disconnected from the jib frame 2. Furthermore, raising and lowering of the jib frame 2 are achieved by adjusting the connecting switch 9, and the following two methods are adopted.

In operating scenarios where high lifting capacity is not required, only the luffing cylinder 4 is used to raise and lower the jib frame 2, in which case, the tower jib connecting frame 3 performs luffing operation, and the connecting switch 9 is engaged, such that the tower jib connecting frame 3 and the jib frame 2 are connected as an integral structure, and the luffing cylinder 4 controls the tower jib connecting frame 3 to raise and lower, directly causing the jib frame 2 to raise and lower.

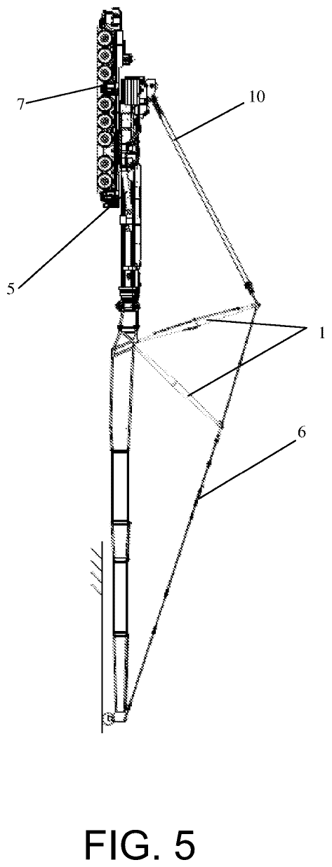

In operating scenarios where high lifting capacity is required, another method is used to raise and lower the jib frame 2. In this case, the tower jib connecting frame 3 does not perform luffing operation, and the connecting switch 9 thus needs to be disconnected, that is, the tower jib connecting frame 3 is disconnected from the jib frame 2. For this method, a luffing winch 5, a luffing rope 10, and a connecting tie plate 6 are further included, and an end of the luffing rope 10 extends from the luffing winch 5. The mounting assembly structure further includes a support frame 1. Both the support frame 1 and the connecting tie plate 6 extend from an end of the luffing rope 10 away from the luffing winch 5. The other end of the support frame 1 is connected to an end of the first transition joint 81, and the other end of the connecting tie plate 6 is connected to an end of the jib frame 2 away from the transition joint 8. When the connecting switch 9 is disengaged, operation of the luffing winch 5 controls the luffing rope 10 to cause the support frame 1 to rotate, thereby driving the jib frame 2 to raise or lower. Furthermore, at least one support frame is provided, which may be a single support frame, or a plurality of support frames. With reference to FIG. 5, a connection state when two support frames are provided in the disclosure is illustrated.

When an operating scenario changes, various components may be flexibly used. For example, when switching from an operating scenario requiring high lifting capacity to an operating scenario requiring low lifting capacity, the support frame 1, the luffing rope 10, and the connecting tie plate 6 are removed to simplify the structure, and the luffing cylinder 4 is used to raise and lower the jib frame 2, thereby facilitating operation.

In this embodiment, the connecting switch 9 is a pin 11, holes are formed in the first transition joint 81 and the second transition joint 82, and the pin 11 cooperates with the holes to achieve engagement and disengagement. In special operating scenarios, with reference to FIG. 4, the tower jib structure of the disclosure further includes a conversion tie plate 12, and the first transition joint 81 and the second transition joint 82 are disconnected and connected through cooperation between the conversion tie plate 12 and the pin 11.

In addition, a plurality of transition joints 8 and connecting switches 9 cooperating with the transition joints 8 may be provided. Furthermore, in order to maintain the jib frame 2 and the tower jib connecting frame 3 in the same straight line and prevent an end of the jib frame 2 away from the crane 7 from bending toward the crane 7, the following embodiment is provided: at least two transition joints 8 are symmetrically arranged from top to bottom in a lifting direction of the jib frame 2, so as to prevent the end of the jib frame 2 away from the crane 7 from bending toward the crane 7 during hoisting.

In this embodiment, the jib frame 2 includes a transition section, a jib head and other structure.

What is claimed is:

1. A crane, comprising a boom and a luffing cylinder, and further comprising a tower jib structure for function switching, wherein the tower jib structure comprises a jib frame, a tower jib connecting frame connected to the boom, and a mounting assembly structure, the tower jib connecting frame and the jib frame are movably connected or fixedly connected to each other by means of the mounting assembly structure, and the luffing cylinder controls the boom to drive the tower jib connecting frame to raise and lower.

2. A mounting assembly structure having the tower jib structure of claim 1, comprising a transition joint and a connecting switch, wherein the transition joint comprises a first transition joint and a second transition joint; and
the first transition joint is arranged at a front end of the tower jib connecting frame, the second transition joint is arranged at a rear end of the jib frame, and the first transition joint is connected to or disconnected from the second transition joint by means of the connecting switch.

3. The mounting assembly structure according to claim 2, wherein when the connecting switch is engaged, the tower jib connecting frame is connected to the jib frame, and the luffing cylinder controls the tower jib connecting frame to cause the jib frame to raise and lower; and when the connecting switch is disengaged, the tower jib connecting frame is disconnected from the jib frame.

4. The mounting assembly structure according to claim 3, wherein the tower jib structure further comprises a luffing winch, a luffing rope, and a connecting tie plate, and an end of the luffing rope extends from the luffing winch; the mounting assembly structure further comprises a support frame, both the support frame and the connecting tie plate extend from an end of the luffing rope away from the luffing winch, the other end of the support frame is connected to an end of the first transition joint, and the other end of the connecting tie plate is connected to an end of the jib frame away from the transition joint; and when the connecting switch is disengaged, operation of the luffing winch controls the luffing rope to cause the support frame to rotate, thereby driving the jib frame to raise or lower.

5. The mounting assembly structure according to claim 4, wherein at least one support frame is provided.

6. The mounting assembly structure according to claim 2, wherein the connecting switch is a pin, holes are formed in the first transition joint and the second transition joint, and the pin cooperates with the holes to achieve engagement and disengagement.

7. The mounting assembly structure according to claim 6, wherein the tower jib structure further comprises a conversion tie plate, and the first transition joint and the second transition joint are disconnected and connected through cooperation between the conversion tie plate and the pin.

8. The mounting assembly structure according to claim 2, wherein a plurality of transition joints and connecting switches cooperating with the transition joints are provided.

9. The mounting assembly structure according to claim 2, wherein at least two transition joints are symmetrically arranged from top to bottom in a lifting direction of the jib frame.

10. A mounting assembly structure having the tower jib structure of claim 1, comprising a transition joint, a connecting switch, a tower cap connected to the tower jib connecting frame, and a bottom jib section connected to the jib frame; wherein the transition joint comprises a first transition joint and a second transition joint; and
the first transition joint is arranged at a front end of the tower cap, the second transition joint is arranged at a rear end of the bottom jib section, and the first transition joint is connected to or disconnected from the second transition joint by means of the connecting switch.

11. The mounting assembly structure according to claim 10, wherein when the connecting switch is engaged, the tower jib connecting frame is connected to the jib frame, and the luffing cylinder controls the tower jib connecting frame to cause the jib frame to raise and lower; and when the connecting switch is disengaged, the tower jib connecting frame is disconnected from the jib frame.

12. The mounting assembly structure according to claim 11, wherein the tower jib structure further comprises a luffing winch, a luffing rope, and a connecting tie plate, and an end of the luffing rope extends from the luffing winch; the mounting assembly structure further comprises a support frame, both the support frame and the connecting tie plate extend from an end of the luffing rope away from the luffing winch, the other end of the support frame is connected to an end of the first transition joint, and the other end of the connecting tie plate is connected to an end of the jib frame away from the transition joint; and when the connecting switch is disengaged, operation of the luffing winch controls the luffing rope to cause the support frame to rotate, thereby driving the jib frame to raise or lower.

13. The mounting assembly structure according to claim 12, wherein at least one support frame is provided.

14. The mounting assembly structure according to claim 10, wherein the connecting switch is a pin, holes are formed in the first transition joint and the second transition joint, and the pin cooperates with the holes to achieve engagement and disengagement.

15. The mounting assembly structure according to claim 14, wherein the tower jib structure further comprises a conversion tie plate, and the first transition joint and the second transition joint are disconnected and connected through cooperation between the conversion tie plate and the pin.

16. The mounting assembly structure according to claim 10, wherein a plurality of transition joints and connecting switches cooperating with the transition joints are provided.

17. The mounting assembly structure according to claim 10, wherein at least two transition joints are symmetrically arranged from top to bottom in a lifting direction of the jib frame.
